(19) United States
(12) Patent Application Publication
(10) Pub. No.: US 2021/0157696 A1
(43) Pub. Date: May 27, 2021

(54) RADIO FREQUENCY TEST AND MEASUREMENT DEVICE, SYSTEM AND METHOD

(71) Applicant: Rohde & Schwarz GmbH & Co. KG, Munich (DE)

(72) Inventors: Clemens LOHMER, Munich (DE); Leonhard BRADER, Nussdorf am Inn (DE); Theodor SEITZ, Munich (DE)

(21) Appl. No.: 16/692,778

(22) Filed: Nov. 22, 2019

(51) Int. Cl. G06F 11/22; H04L 29/08; G06F 8/61; G06Q 20/08

(52) U.S. Cl. CPC G06F 11/2273; G06Q 20/085; G06F 8/61; H04L 67/34

(57) ABSTRACT

A radio frequency test and measurement device is provided. The radio frequency test and measurement device comprises a download unit, wherein the download unit is configured to download data from a server. In addition to this, the downloaded data comprises a predefined time limit and/or at least one use limit with respect to functionality of the radio frequency test and measurement device.

### TECHNICAL FIELD

The invention relates to a radio frequency test and measurement device, a radio frequency test and measurement system, and a radio frequency test and measurement method.

### BACKGROUND ART

Generally, in times of an increasing number of applications providing wireless communication capabilities, there is a growing need of a radio frequency test and measurement device, system and method for performing radio frequency tests and measurements with respect to a device under test comprising such an application in order to verify correct functioning of said applications in a highly accurate and efficient manner.

In this context of testing and measuring, users commonly have to buy several testing and measurement devices and additional hardware for executing radio frequency test and measurements. On the one hand, test cases have to be configured in the respective devices and hardware by the user, and on the other hand, software on each of said devices and hardware has to be maintained, which disadvantageously leads to inefficiency and even inaccuracies.

Accordingly, there is a need to provide a radio frequency test and measurement device, a radio frequency test and measurement system, and a radio frequency test and measurement method, whereby both a high accuracy and a high efficiency are ensured.

### SUMMARY OF THE INVENTION

According to a first aspect of the invention, a radio frequency test and measurement device is provided. The radio frequency test and measurement device comprises a download unit, wherein the download unit is configured to download data from a server. In addition to this, the downloaded data comprises a predefined time limit and/or at least one use limit with respect to functionality of the radio frequency test and measurement device.

Advantageously, said functionality may comprise a configuration for at least one input and/or at least one output, preferably at least one input or output port of the radio frequency test and measurement device, and/or a graphical user interface of the radio frequency test and measurement device. Further advantageously, said configuration may especially be based on the downloaded data. It is noted that outside the predefined time limit, the radio frequency test and measurement device may especially not work. It is further noted that the download unit may comprise a network connection. Furthermore, the download unit may especially comprise or be a downloader. As a further advantage, the communication between the download unit or the downloader, respectively, and the server may especially be via a network router preferably to another network or network address area.

According to a first preferred implementation form of the first aspect of the invention, the server is an internet server. Additionally or alternatively, the download unit is configured to install data, preferably the downloaded data or a part thereof.

Advantageously, a user may engage a configuration wizard on the server via a client computer system over a network such as the internet. In this context, the foregoing client/server model especially describes a relationship between two computer programs, in which one program, the client, makes a service request from another program, the server, which fulfills the request. Further advantageously, the server may be located in the internet or a local area network.

As a further advantage, the server or the internet server, respectively, may especially allow a user to configure complete test sequences and/or test systems preferably in the form of a digital twin. Furthermore, the server may recommend the user the respective hardware to buy or rent. Further additionally, the server may especially detect certain measurement devices being connected and may preferably configure the respective test setup on the devices.

According to a second preferred implementation form of the first aspect of the invention, the radio frequency test and measurement device further comprises a processing unit. In this context, the processing unit is configured on the basis of the downloaded data.

Advantageously, the processing unit may be configured to perform at least baseband processing. Further advantageously, the processing unit may especially comprise or be a processor or a controller.

According to a further preferred implementation form of the first aspect of the invention, the radio frequency test and measurement device further comprises a user interface. In this context, the user interface is configured on the basis of the downloaded data.

Advantageously, the user interface may especially comprise or be configurable user interface. Further advantageously, the user interface, preferably the configurable user interface may especially comprise a graphical user interface.

According to a further preferred implementation form of the first aspect of the invention, the radio frequency test and measurement device further comprises at least one input or output port. In this context, the at least one input or output port is switchable between input or output on the basis of the downloaded data.

Advantageously, the at least one input or output port may especially be a at least one configurable input or output port. Further advantageously, the at least one input or output port, preferably the at least one configurable input or output port, may especially comprise at least one programmable hardware element which is configurable to perform a measurement and/or a control function.

According to a further preferred implementation form of the first aspect of the invention, the download unit is configured to execute or trigger a money transfer via a network connection to a payment server. Additionally or alternatively, the download unit comprises a data connection to a payment system.

Advantageously, for instance, updates with respect to the radio frequency test and measurement device can immediately be payed in a highly efficient manner.

According to a further preferred implementation form of the first aspect of the invention, the radio frequency test and measurement device, preferably the download unit, is configured to delete the downloaded data after expiring of the predefined time limit and/or the at least one use limit.

Advantageously, for instance, this may ensure privacy protection and/or a license enforcement reflash. In other words, the radio frequency test and measurement device, preferably the download unit, may be configured to ensure privacy protection and/or a license enforcement reflash.

Furthermore, it is noted that the downloaded data may especially comprise configuration data and/or measurement data.

According to a further preferred implementation form of the first aspect of the invention, the radio frequency test and measurement device further comprises a maintenance unit, wherein the maintenance unit is configured to deliver result data of a test, preferably a hardware test, to the server or another server. In addition to this or as an alternative, the maintenance unit is configured to adjust a software, preferably a software for download, according to measured data. Further additionally or further alternatively, the maintenance unit is configured to test and/or measure the respective hardware behavior in the radio frequency test and measurement device.

Advantageously, the downloaded software may especially be calibrated. Further advantageously, the downloaded software may comprise or be a calibration data compensated configuration software. As a further advantage, a not identified software configuration on the server may especially be based on respective hardware test data.

According to a further preferred implementation form of the first aspect of the invention, the processing unit is configured to process measurement data calculation, preferably a Fourier transform, more preferably a fast Fourier transform, internally. In addition to this or as an alternative, the processing unit is configured to forward processing steps or to complete processing to the server or another server, preferably a web-server. Further additionally or further alternatively, the processing unit is configured to decide between a local calculation or a server calculation on the basis of a predefined real-time request.

Advantageously, for instance, efficiency can further be increased.

According to a further preferred implementation form of the first aspect of the invention, the processing unit is configured to identify a network connection status, preferably an internet connection status. In this context, the processing unit is configured to execute at least one predefined security rule on the basis of the network connection status, preferably the internet connection status.

Advantageously, the processing unit may be configured to not allow a company confidential measurement. Further advantageously, the processing unit may be configured to delete respective saved data when corresponding connection is establishing.

According to a further preferred implementation form of the first aspect of the invention, the processing unit is configured to execute at least one of a generation sequence, a test sequence, a measure sequence, or any combination thereof on the basis of the downloaded data. Additionally or alternatively, the processing unit is configured to be configurable with the aid of downloaded data representing a certification test of standardization.

Advantageously, test or measure sequence may especially configure at least one input and/or at least one output and/or at least one setting of the radio frequency test and measurement device at a predefined point in time preferably during operation.

According to a further preferred implementation form of the first aspect of the invention, the downloaded data comprises at least one of a license key, a measurement application, a generation application, a test application, a complete image of device software, an interface definition to other test and/or measurement devices, or any combination thereof.

Advantageously, flexibility can further be increased, thereby also increasing efficiency.

According to a further preferred implementation form of the first aspect of the invention, the radio frequency test and measurement device further comprises an interferer unit being configured on the basis of the downloaded data. Additionally or alternatively, the radio frequency test and measurement device further comprises a predistortion unit being configured on the basis of the downloaded data. Further additionally or further alternatively, the radio frequency test and measurement device further comprises a trigger unit being configured on the basis of the downloaded data. In addition to this or as an alternative, the radio frequency test and measurement device further comprises a frequency selector being configured on the basis of the downloaded data.

Advantageously, the interferer unit may especially be an interferer, the predistortion unit may especially be a predistorter, and the trigger unit may especially be a trigger. Further advantageously, with respect to the trigger unit or trigger, respectively, a user may graphically or manually select at least one component in the respective configuration and may preferably set at least one of timing, triggering, synchronization parameters, or any combination thereof for the at least one selected component.

According to a further preferred implementation form of the first aspect of the invention, the download unit is configured to be remote-controllable preferably by a mobile communication device. In addition to this or as an alternative, the download unit comprises at least one cybersecurity feature.

Advantageously, for instance, flexibility can further be increased, which leads to an increased efficiency. Further advantageously, it is noted that the download unit may preferably be in or may especially be comprised by a separate device.

According to a further preferred implementation form of the first aspect of the invention, the radio frequency test and measurement device, preferably the download unit, is configured to configure data to be downloaded for a user on the server before download.

Advantageously, as an alternative, the data to be downloaded for a user may be configured on the server before download with the aid of mobile communication device in a remote manner.

Further advantageously, at least two radio frequency test and measurement devices may especially be connected to a logical server via a communication network, preferably via the internet. In this context, software to be downloaded may especially be configured on the logical server for each of the at least two radio frequency test and measurement devices preferably on the basis of a user input delivered to the logical server. The user input may especially be delivered via the internet. Furthermore, the user input may especially be a user input at the respective radio frequency test and measurement device or at a mobile communication device.

According to a further preferred implementation form of the first aspect of the invention, the at least one input or output port comprises or is a radio frequency signal input or output port. As an alternative, the at least one input or output port comprises or is an input or output port for at least one digital signal representing a radio frequency signal.

Advantageously, for instance, accuracy can further be increased.

According to a further preferred implementation form of the first aspect of the invention, the radio frequency test and measurement device further comprises a digital to radio frequency converter, preferably a connectable digital to radio frequency converter. In addition to this or as an alternative, the radio frequency test and measurement device further comprises a radio frequency to digital converter, preferably a connectable radio frequency to digital converter.

Advantageously, for example, inaccuracy can further be reduced.

According to a further preferred implementation form of the first aspect of the invention, the radio frequency test and measurement device further comprises a data packet analysis unit. In this context, the data packet analysis unit is configured to identify and/or show target of data communication of the radio frequency test and measurement device.

Advantageously, for instance, both accuracy and efficiency can further be increased.

According to a second aspect of the invention, a radio frequency test and measurement system is provided. The radio frequency test and measurement system comprises at least one radio frequency test and measurement device according to the first aspect of the invention, and a server.

Advantageously, the radio frequency test and measurement system may especially comprise at least two radio frequency test and measurement devices.

According to a third aspect of the invention, a radio frequency test and measurement method is provided. The radio frequency test and measurement method comprises the steps of downloading data from a server with the aid of a download unit of a radio frequency test and measurement device, wherein the downloaded data comprises a predefined time limit and/or at least one use limit with respect to functionality of the radio frequency test and measurement device, and installing the downloaded data or a part thereof on the radio frequency test and measurement device.

Advantageously, said functionality may comprise a configuration for at least one input and/or at least one output, preferably at least one input or output port of the radio frequency test and measurement device, and/or a graphical user interface of the radio frequency test and measurement device. Further advantageously, said configuration may especially be based on the downloaded data. It is noted that outside the predefined time limit, the radio frequency test and measurement device may especially not work.

### BRIEF DESCRIPTION OF THE DRAWINGS

Exemplary embodiments of the invention are now further explained with respect to the drawings by way of example only, and not for limitation. In the drawings:

FIG. 1 shows an exemplary embodiment of the first aspect of the invention;

FIG. 2 shows a further exemplary embodiment of the first aspect of the invention;

FIG. 3 shows a further exemplary embodiment of the first aspect of the invention;

FIG. 4 shows a further exemplary embodiment of the first aspect of the invention;

FIG. 5 shows a further exemplary embodiment of the first aspect of the invention;

FIG. 6 shows a further exemplary embodiment of the first aspect of the invention;

FIG. 7 shows a further exemplary embodiment of the first aspect of the invention;

FIG. 8 shows a further exemplary embodiment of the first aspect of the invention;

FIG. 9 shows a further exemplary embodiment of the first aspect of the invention;

FIG. 10 shows a further exemplary embodiment of the first aspect of the invention;

FIG. 11 shows a further exemplary embodiment of the first aspect of the invention;

FIG. 12 shows a further exemplary embodiment of the first aspect of the invention;

FIG. 13 shows a further exemplary embodiment of the first aspect of the invention;

FIG. 14 shows an exemplary embodiment of the second aspect of the invention; and

FIG. 15 shows a flow chart of an exemplary embodiment of the third aspect of the invention.

### DETAILED DESCRIPTION OF THE PREFERRED EMBODIMENTS

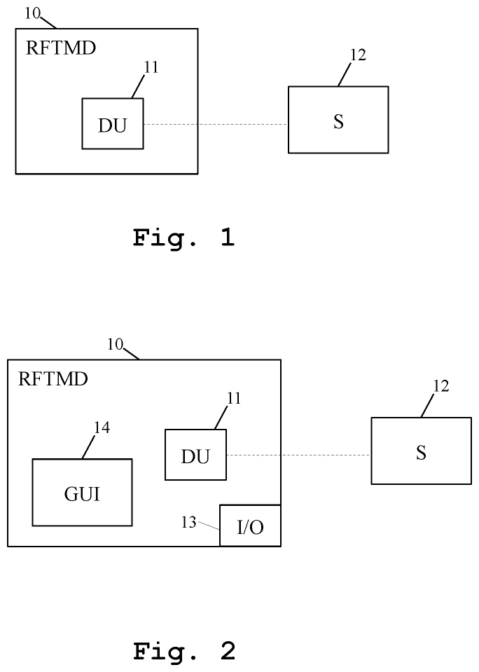

Firstly, FIG. 1 illustrates an exemplary embodiment of the inventive radio frequency test and measurement device 10.

The radio frequency test and measurement device 10 comprises a download unit 11.

In this context, the download unit 11 downloads data from a server 12. In addition to this, the downloaded data comprises a predefined time limit and/or at least one use limit with respect to functionality of the radio frequency test and measurement device.

Furthermore, according to a second embodiment depicted by

FIG. 2, said functionality comprises a configuration for at least one input and/or at least one output, preferably at least one input or output port 13 of the radio frequency test and measurement device 10, and/or a graphical user interface 14 of the radio frequency test and measurement device 10.

In this context, said configuration may especially be based on the downloaded data. It is noted that outside the predefined time limit, the radio frequency test and measurement device 10 may especially not work. It is further noted that the download unit may comprise a network connection. In addition to this or as an alternative, the communication between the download unit 11 and the server 12 may especially be via a network router preferably to another network or network address area.

With respect to the server 12, it is noted that the server 12 may especially be an internet server. Additionally or alternatively, the download unit 11 may be configured to install data, preferably the downloaded data or a part thereof.

In further addition to this or as a further alternative, again with respect to the server 12, it is noted that a user may engage a configuration wizard on the server 12 via a client computer system over a network such as the internet. In this context, the foregoing client/server model especially describes a relationship between two computer programs, in which one program, the client, makes a service request from another program, the server, which fulfills the request. Further advantageously, the server 12 may be located in the internet or a local area network.

Moreover, the server 12 or the internet server, respectively, may especially allow a user to configure complete test sequences and/or test systems preferably in the form of a digital twin. Furthermore, the server 12 may recommend the user the respective hardware to buy or rent.

Further additionally, the server 12 may especially detect certain measurement devices being connected and may preferably configure the respective test setup on the corresponding devices.

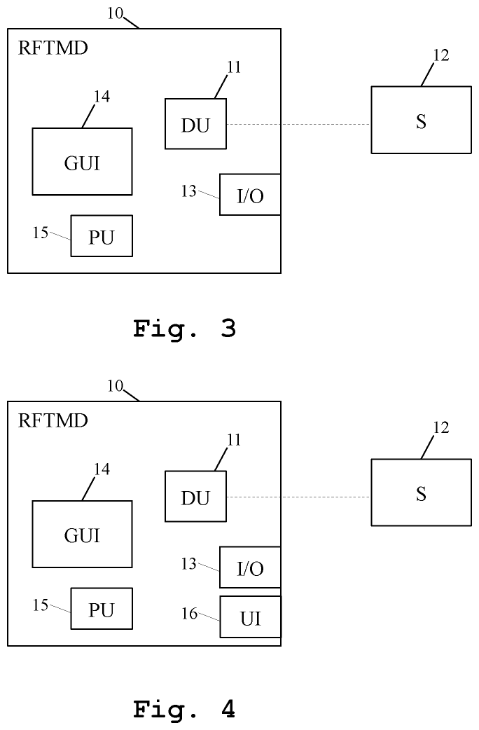

According to a further embodiment shown in FIG. 3, the radio frequency test and measurement device 10 further comprises a processing unit 15. In this context, the processing unit 15 is configured on the basis of the downloaded data.

In this context, the processing unit 15 may be configured to perform at least baseband processing. It is further noted that the processing unit 15 may especially comprise or be a processor or a controller.

Furthermore, as it can be seen from FIG. 4, according to a further embodiment, the radio frequency test and measurement device 10 further comprises a user interface 16. In this context, the user interface 16 is configured on the basis of the downloaded data.

In this context, the user interface 16 may especially comprise or be configurable user interface. Further advantageously, the user interface, preferably the configurable user interface, may especially comprise a graphical user interface, for instance, the graphical user interface 14.

With respect to the at least one input or output port 13, it is noted that the at least one input or output port 13 may especially be switchable between input or output on the basis of the downloaded data.

Furthermore, the at least one input or output port 13 may especially be a at least one configurable input or output port. In addition to this or as an alternative, the at least one input or output port 13, preferably the at least one configurable input or output port, may especially comprise at least one programmable hardware element which is configurable to perform a measurement and/or a control function.

Moreover, with respect to the download unit 11 of the radio frequency test and measurement device 10, the download unit 11 may especially be configured to execute or trigger a money transfer via a network connection to a payment server. Additionally or alternatively, the download unit 11 may comprises a data connection to a payment system.

Accordingly, for instance, updates with respect to the radio frequency test and measurement device 10 can immediately be payed in a highly efficient manner.

In addition to this or as an alternative, the radio frequency test and measurement device 10, preferably the download unit 11, may especially be configured to delete the downloaded data after expiring of the predefined time limit and/or the at least one use limit.

As an advantage, for instance, this may especially ensure privacy protection and/or a license enforcement reflash. In other words, the radio frequency test and measurement device 10, preferably the download unit 11, may be configured to ensure privacy protection and/or a license enforcement reflash. Further advantageously, it is noted that the downloaded data may especially comprise configuration data and/or measurement data.

As it can be seen from FIG. 5, according to a further embodiment, the radio frequency test and measurement device 10 further comprises a maintenance unit 17.

In this context, the maintenance unit 17 is configured to deliver result data of a test, preferably a hardware test, to the server 12 or another server. In addition to this or as an alternative, the maintenance unit 17 may be configured to adjust a software, preferably a software for download, according to measured data. Further additionally or further alternatively, the maintenance unit 17 may be configured to test and/or measure the respective hardware behavior in the radio frequency test and measurement device 10.

As an advantage, the downloaded software may especially be calibrated. Further advantageously, the downloaded software may comprise or be a calibration data compensated configuration software. As a further advantage, a not identified software configuration on the server 12 may especially be based on respective hardware test data.

Again, with respect to the processing unit 15, the processing unit 15 may further be configured to internally process measurement data calculation, preferably a Fourier transform, more preferably a fast Fourier transform.

In addition to this or as an alternative, the processing unit 15 may be configured to forward processing steps or to complete processing to the server 12 or another server, preferably a web-server. Further additionally or further alternatively, the processing unit 12 may be configured to decide between a local calculation or a server calculation on the basis of a predefined real-time request.

Moreover, it is noted that it might be particularly advantageous if the processing unit 15 is configured to identify a network connection status, preferably an internet connection status. In this context, the processing unit 15 may especially be configured to execute at least one predefined security rule on the basis of the network connection status, preferably the internet connection status.

Additionally or alternatively, the processing unit 15 may be configured to not allow a company confidential measurement. Further advantageously, the processing unit may be configured to delete respective saved data when corresponding connection is establishing.

Furthermore, the processing unit 15 may additionally or alternatively be configured to execute at least one of a generation sequence, a test sequence, a measure sequence, or any combination thereof on the basis of the downloaded data. Further additionally or alternatively, the processing unit 15 may be configured to be configurable with the aid of downloaded data representing a certification test of standardization.

As an advantage, it is noted that the test or measure sequence may especially configure at least one input and/or at least one output such as port 13 and/or at least one setting of the radio frequency test and measurement device at a predefined point in time preferably during operation.

With respect to the downloaded data, it is noted that it might be particularly advantageous if the downloaded data comprises at least one of a license key, a measurement application, a generation application, a test application, a complete image of device software, an interface definition to other test and/or measurement devices, or any combination thereof.

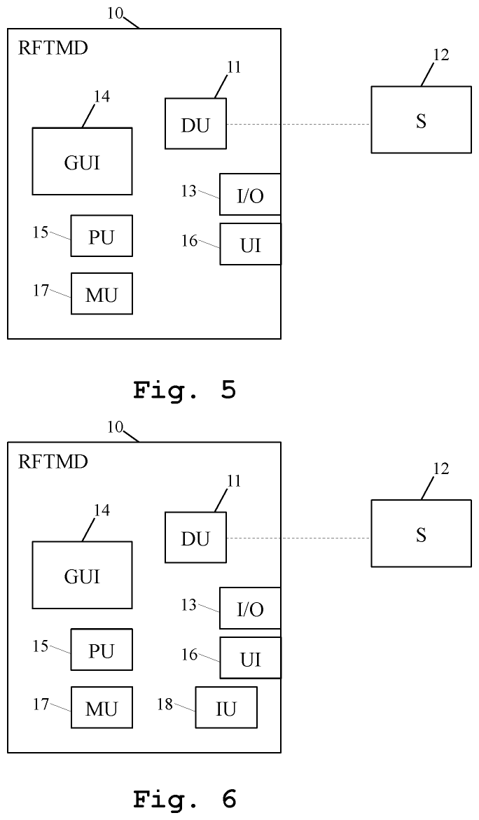

Now, with respect to a further embodiment according to FIG. 6, the radio frequency test and measurement device 10 further comprises an interferer unit 18. In this context, the interferer unit 18 is configured on the basis of the downloaded data.

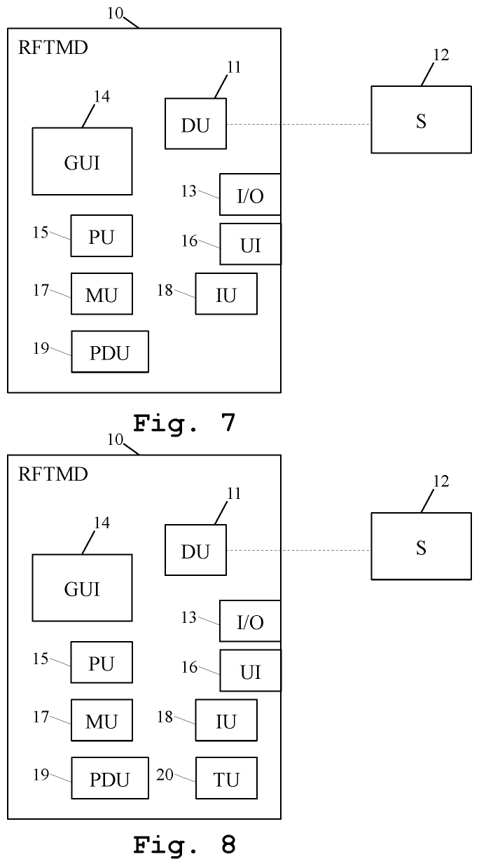

Furthermore, FIG. 7 shows another embodiment, wherein the radio frequency test and measurement device 10 further comprises a predistortion unit 19. In this context, the predistortion unit 19 is configured on the basis of the downloaded data.

Moreover, according to a further embodiment illustrated by

FIG. 8, the radio frequency test and measurement device 10 further comprises a trigger unit 20. In this context, the trigger unit 20 is configured on the basis of the downloaded data.

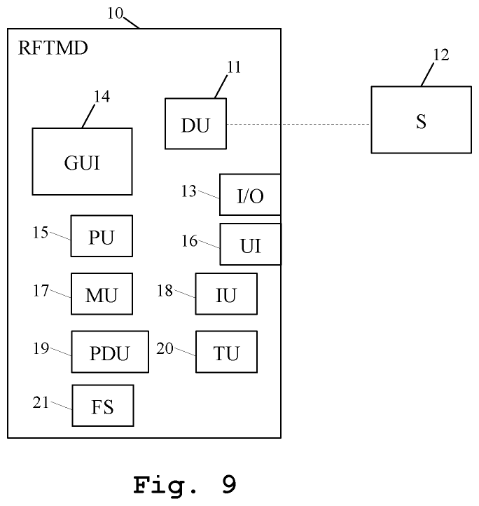

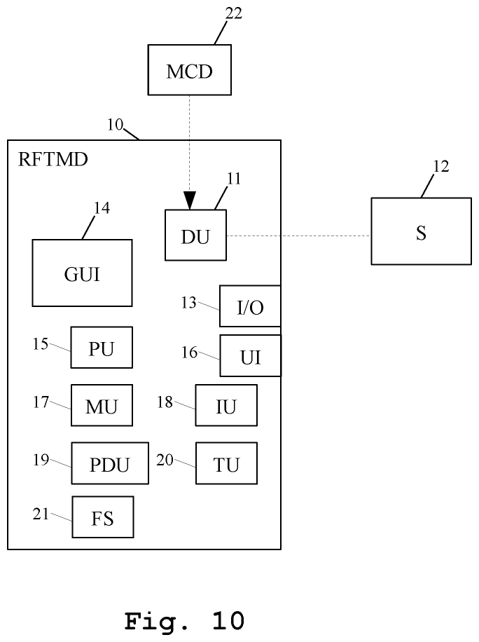

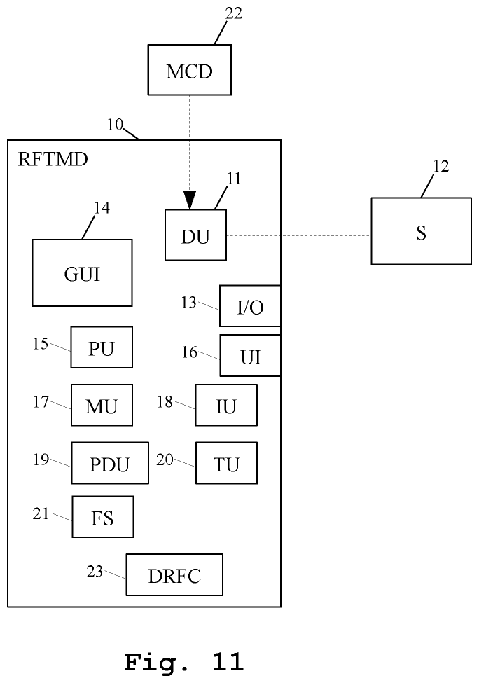

As it can further be seen from FIG. 9 depicting another embodiment, the radio frequency test and measurement device further comprises a frequency selector 21. In this context, the frequency selector 21 is configured on the basis of the downloaded data.

Again, with respect to the trigger unit 20, it is noted that a user may graphically or manually select at least one component in the respective configuration and may preferably set at least one of timing, triggering, synchronization parameters, or any combination thereof for the at least one selected component.

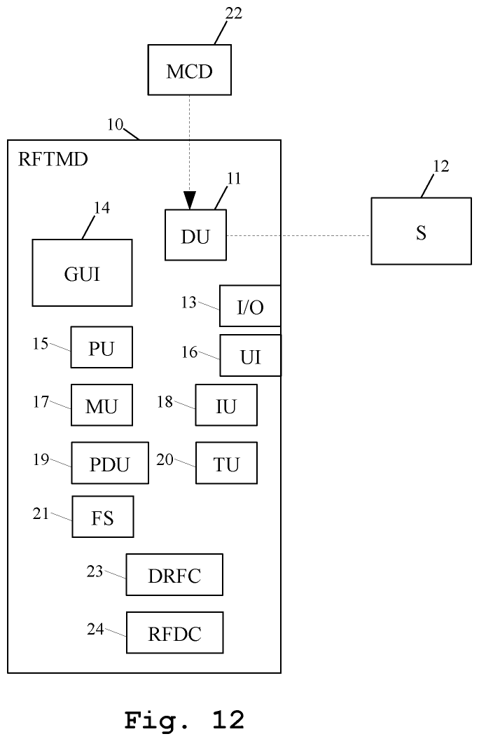

With respect to the download unit 11, it is further noted that it might be particularly advantageous if the download unit 11 is configured to be remote-controllable preferably by a mobile communication device 22 as illustrated by FIG. 10. Furthermore, the download unit 11 may especially comprise at least one cybersecurity feature.

It is further noted that it might be particularly advantageous if the radio frequency test and measurement device 10, preferably the download unit 11, is configured to configure data to be downloaded for a user on the server 12 before download.

Advantageously, as an alternative, the data to be downloaded for a user may be configured on the server 12 before download with the aid of mobile communication device such as the mobile communication device 22 in a remote manner.

Again, with respect to the at least one input or output port 13, it is noted that the at least one input or output port 13 may especially comprise or be a radio frequency signal input or output port. As an alternative, the at least one input or output port 13 may especially comprise or be an input or output port for at least one digital signal representing a radio frequency signal.

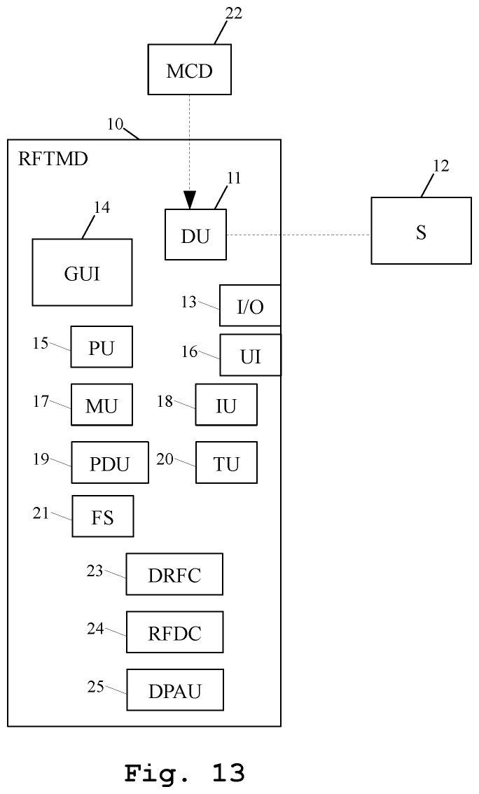

According to a further embodiment, as it can be seen from FIG. 11, the radio frequency test and measurement device 10 further comprises a digital to radio frequency converter 23, preferably a connectable digital to radio frequency converter. In this context, the digital to radio frequency converter 23, preferably the connectable digital to radio frequency converter, may especially be configured to convert a digital signal to a radio frequency signal.

In accordance with FIG. 12 showing another embodiment, the radio frequency test and measurement device 10 further comprises a radio frequency to digital converter 24, preferably a connectable radio frequency to digital converter. In this context, the radio frequency to digital converter 24, preferably the connectable radio frequency to digital converter, may especially be configured to convert a radio frequency signal to a digital signal.

Now, with respect to FIG. 13, a further embodiment is depicted. In this context, the radio frequency test and measurement device 10 further comprises a data packet analysis unit 25. In addition to this, the data packet analysis unit 25 is configured to identify and/or show target of data communication of the radio frequency test and measurement device 10.

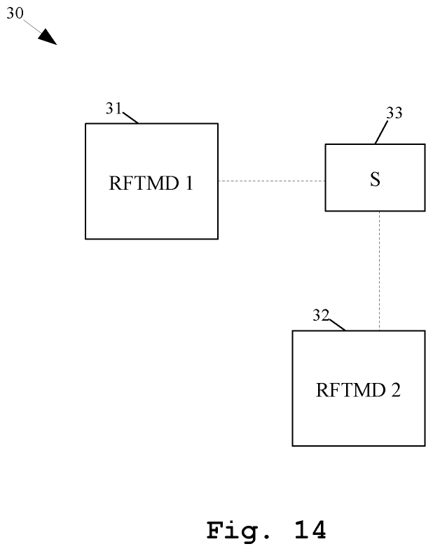

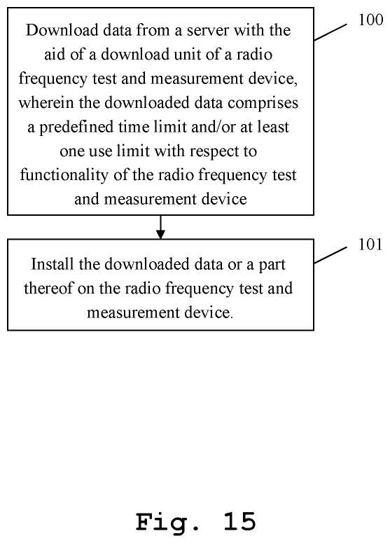

In accordance with FIG. 14, a radio frequency test and measurement system 30 is illustrated. The radio frequency test and measurement system 30 comprises at least one, exemplarily two 31 and 32, radio frequency test and measurement device according to any of the embodiments of FIG. 1 to FIG. 13 described above, and a server 33 such as the server 12 in the sense of the foregoing embodiments.

It is further noted that the two radio frequency test and measurement devices 31 and 32 may especially be connected to the server 33, preferably a logical server, via a communication network, preferably via the internet. In this context, software to be downloaded may especially be configured on the server 33 or the logical server, respectively, for each of the two radio frequency test and measurement devices 31 and 32 preferably on the basis of a user input delivered to the server or the logical server, respectively. The user input may especially be delivered via the internet. Furthermore, the user input may especially be a user input at the respective radio frequency test and measurement device 31, 32 or at a mobile communication device such as the mobile communication device 22 having already been depicted in the context of FIG. 10 to FIG. 13.

Finally, FIG. 4 shows a flow chart of an exemplary embodiment of the inventive radio frequency test and measurement method. In a first step 100, data is downloaded from a server with the aid of a download unit of a radio frequency test and measurement device, wherein the downloaded data comprises a predefined time limit and/or at least one use limit with respect to functionality of the radio frequency test and measurement device. Then, in a second step 101, the downloaded data or a part thereof is installed on the radio frequency test and measurement device.

In this context, it is noted that said functionality may comprise a configuration for at least one input and/or at least one output, preferably at least one input or output port of the radio frequency test and measurement device, and/or a graphical user interface of the radio frequency test and measurement device. It is further noted that said configuration may especially be based on the downloaded data. It is noted that outside the predefined time limit, the radio frequency test and measurement device may especially not work.

While various embodiments of the present invention have been described above, it should be understood that they have been presented by way of example only, and not limitation. Numerous changes to the disclosed embodiments can be made in accordance with the disclosure herein without departing from the spirit or scope of the invention. Thus, the breadth and scope of the present invention should not be limited by any of the above described embodiments. Rather, the scope of the invention should be defined in accordance with the following claims and their equivalents.

Although the invention has been illustrated and described with respect to one or more implementations, equivalent alterations and modifications will occur to others skilled in the art upon the reading and understanding of this specification and the annexed drawings. In addition, while a particular feature of the invention may have been disclosed with respect to only one of several implementations, such feature may be combined with one or more other features of the other implementations as may be desired and advantageous for any given or particular application.

What is claimed is:

1. A radio frequency test and measurement device comprising:
a download unit,
wherein the download unit is configured to download data from a server, and
wherein the downloaded data comprises a predefined time limit and/or at least one use limit with respect to functionality of the radio frequency test and measurement device.

2. The radio frequency test and measurement device according to claim 1,
wherein the server is an internet server, and/or
wherein the download unit is configured to install data, preferably the downloaded data or a part thereof.

3. The radio frequency test and measurement device according to claim 1,
wherein the radio frequency test and measurement device further comprises a processing unit,
wherein the processing unit is configured on the basis of the downloaded data.

4. The radio frequency test and measurement device according to claim 1,
wherein the radio frequency test and measurement device further comprises a user interface,
wherein the user interface is configured on the basis of the downloaded data.

5. The radio frequency test and measurement device according to claim 1,
wherein the radio frequency test and measurement device further comprises at least one input or output port,
wherein the at least one input or output port is switchable between input or output on the basis of the downloaded data.

6. The radio frequency test and measurement device according to claim 1,
wherein the download unit is configured to execute or trigger a money transfer via a network connection to a payment server, and/or
wherein the download unit comprises a data connection to a payment system.

7. The radio frequency test and measurement device according to claim 1,
wherein the radio frequency test and measurement device, preferably the download unit, is configured to delete the downloaded data after expiring of the predefined time limit and/or the at least one use limit.

8. The radio frequency test and measurement device according to claim 1,
wherein the radio frequency test and measurement device further comprises a maintenance unit,
wherein the maintenance unit is configured to deliver result data of a test, preferably a hardware test, to the server or another server, and/or
wherein the maintenance unit is configured to adjust a software, preferably a software for download, according to measured data, and/or
wherein the maintenance unit is configured to test and/or measure the respective hardware behavior in the radio frequency test and measurement device.

9. The radio frequency test and measurement device according to claim 3,
wherein the processing unit is configured to process measurement data calculation, preferably a Fourier transform, more preferably a fast Fourier transform, internally, and/or
wherein the processing unit is configured to forward processing steps or to complete processing to the server or another server, preferably a web-server, and/or
wherein the processing unit is configured to decide between a local calculation or a server calculation on the basis of a predefined real-time request.

10. The radio frequency test and measurement device according to claim 3,
wherein the processing unit is configured to identify a network connection status, preferably an internet connection status,
wherein the processing unit is configured to execute at least one predefined security rule on the basis of the network connection status, preferably the internet connection status.

11. The radio frequency test and measurement device according to claim 3,
wherein the processing unit is configured to execute at least one of a generation sequence, a test sequence, a measure sequence, or any combination thereof on the basis of the downloaded data, and/or
wherein the processing unit is configured to be configurable with the aid of downloaded data representing a certification test of standardization.

12. The radio frequency test and measurement device according to claim 1,
wherein the downloaded data comprises at least one of a license key, a measurement application, a generation application, a test application, a complete image of device software, an interface definition to other test and/or measurement devices, or any combination thereof.

13. The radio frequency test and measurement device according to claim 1,
wherein the radio frequency test and measurement device further comprises an interferer unit being configured on the basis of the downloaded data, and/or
wherein the radio frequency test and measurement device further comprises a predistortion unit being configured on the basis of the downloaded data, and/or
wherein the radio frequency test and measurement device further comprises a trigger unit being configured on the basis of the downloaded data, and/or
wherein the radio frequency test and measurement device further comprises a frequency selector being configured on the basis of the downloaded data.

14. The radio frequency test and measurement device according to claim 1,
wherein the download unit is configured to be remote-controllable preferably by a mobile communication device, and/or
wherein the download unit comprises at least one cybersecurity feature.

15. The radio frequency test and measurement device according to claim 1,
wherein the radio frequency test and measurement device, preferably the download unit, is configured to configure data to be downloaded for a user on the server before download.

16. The radio frequency test and measurement device according to claim 5,
wherein the at least one input or output port comprises or is a radio frequency signal input or output port, or
wherein the at least one input or output port comprises or is an input or output port for at least one digital signal representing a radio frequency signal.

17. The radio frequency test and measurement device according to claim 1,
wherein the radio frequency test and measurement device further comprises a digital to radio frequency converter, preferably a connectable digital to radio frequency converter, and/or
wherein the radio frequency test and measurement device further comprises a radio frequency to digital converter, preferably a connectable radio frequency to digital converter.

18. The radio frequency test and measurement device according to claim 5,
wherein the radio frequency test and measurement device further comprises a data packet analysis unit,
wherein the data packet analysis unit is configured to identify and/or show target of data communication of the radio frequency test and measurement device.

19. A radio frequency test and measurement system comprising:
at least one radio frequency test and measurement device according to claim 1, and
a server.

20. A radio frequency test and measurement method comprising the steps of:
downloading data from a server with the aid of a download unit of a radio frequency test and measurement device, wherein the downloaded data comprises a predefined time limit and/or at least one use limit with respect to functionality of the radio frequency test and measurement device, and
installing the downloaded data or a part thereof on the radio frequency test and measurement device.
